(19) United States
(12) Patent Application Publication
(10) Pub. No.: US 2022/0081629 A1
(43) Pub. Date: Mar. 17, 2022

(54) METHODS, PROCESSES AND SYSTEMS FOR THE PRODUCTION OF HYDROGEN FROM WASTE, BIOGENIC WASTE AND BIOMASS

(71) Applicant: Solena Group, Inc., Washington, DC (US)

(72) Inventors: Robert T. Do, Potomac, MD (US); Sylvain André Luc Motycka, Washington, DC (US)

(21) Appl. No.: 17/474,729

(22) Filed: Sep. 14, 2021

Related U.S. Application Data
(60) Provisional application No. 63/077,894, filed on Sep. 14, 2020.

(51) Int. Cl. C10J 3/20; C01B 3/02; C10J 3/32; C10J 3/72

(52) U.S. Cl. CPC C10J 3/20; C01B 3/02; C10J 3/32; C10J 2300/092; C10J 2300/0906; C10J 2300/0916; C10J 2300/0946; C10J 3/723

(57) ABSTRACT

Provided herein are novel devices, systems, and methods of using the same, that enable plasma-enhanced gasification of biogenic hydrocarbon waste material comprising: a geometrically designed reactor having a biochar carbon catalyst bed, together with a gas inlet system disposed around a lower section of the apparatus to supply oxidant gas generated by an integrated oxygen absorber system; to enhance the partial oxidation of biogenic hydrocarbon waste materials using exothermic heat generated by an oxidation reaction created in part by the integrated oxygen absorber system into the apparatus, in order to optimize the quantity and quality of hydrogen production in the synthetic gas produced therein.

### CROSS-REFERENCE TO RELATED PATENT APPLICATIONS

The present application claims priority to and all the benefits of U.S. Provisional Patent Application No. 63/077,894, filed on Sep. 14, 2020, which is hereby expressly incorporated herein by reference in its entirety.

### FIELD OF THE INVENTION

Embodiments of the present disclosure relate to methods, processes, and systems for the manufacture of high purity hydrogen from biomass waste. Included herein are methods, processes, and systems wherein biomass waste, such as biogenic hydrocarbon waste, is introduced into a gasifier, and wherein the gasifier comprises an integrated oxygen absorption system for producing oxygen enriched air. The oxygen enriched air combines with the biogenic hydrocarbon to generate heat under an exothermic oxidation process which is then enhanced with an external heat source generated by plasma arc torches to produce high purity green renewable hydrogen.

### BACKGROUND OF THE INVENTION

Studies from the United Nations (UN), Intergovernmental Panel on Climate Change (IPCC), and Environmental Protection Agency (EPA) and other public organizations confirm that worldwide energy requirements are becoming a serious and crucial issue because consumption is increasing at alarming rates due to increasing population and industrialization. Unfortunately, most of the world's energy is produced from the combustion of coal, oil or natural gas, which has been proven to result in the alarming rise of greenhouse gases, subsequent global warming and climate change.

One clear and indisputable solution to the above issues is the development of green and renewable energy sources. The need for such solutions has resulted in the rapid growth of wind and solar energy technology development worldwide. However, at least one drawback of relying on wind and solar energy is that these energy sources are intermittent in nature, as well as geographically and weather dependent. Importantly, they create several other major complications, including but not limited to: the failure to address the 40% of energy usage for transportation/mobility, production of imbalance and instability in the power grid, difficulties related to storage of large quantities of power, inconsistent and seasonal power production; lack of contribution to the decarbonization of infrastructure (such as natural gas pipelines); and inability to generate high heat required in large industries such as cement or steel mills.

The mobility and transportation industry is mostly dependent on petroleum based liquid fuel such as gasoline, diesel and kerosene, and demand for such fuels is growing rapidly due to increasing population growth and increasing travel. With the development of an integrated worldwide economy, the fuel needs of the aviation and shipping industry in particular are increasing exponentially. Agriculture based bio-fuels such as bio-ethanol and bio-diesel have not been able to provide measurable changes in greenhouse gas (GHG) reduction and have contributed to conflicts based food versus fuels.

With the successful commercialization of electric vehicles, there has significant progress in the development of electric motors. The electricity can be delivered to the vehicles using batteries to provide stored electricity in the vehicles; however, batteries are suboptimal for a variety of reasons including the fact that they are typically large and heavy, take a long time to charge (mostly from non-renewable electric sources), and have limited ranges (over less than 200 miles per charge). Electric battery vehicles (EBV) have difficulty in meeting requirements for long haul vehicles such as trucks, buses, trains and ships. With the advancement and commercialization of fuel cell systems, electricity can be delivered to the vehicles via hydrogen which can be stored and converted into electricity via the fuel cell systems. Hydrogen fuel cell electric vehicles (FCEV) are becoming the zero emission vehicle of choice for major car manufacturers due to a hydrogen tank/fuel cell stack which is both compact and lightweight, which is capable of instant charging or fueling within few minutes, and also has the capacity to provide enough electricity for ranges up to 500 miles. similar to gasoline/diesel fueled vehicles.

The concept of green hydrogen and utilizing hydrogen to address the world's energy needs and problems was introduced as a “simple solution” by American biochemical engineer, Patrick Kenji Takahashi. Hydrogen is the simplest element on the periodic table and the most abundant in the universe. It is always found combined with other elements and must be separated from hydrocarbons (e.g., methane CH₄) or water (H₂O) for use as an energy carrier. When energy is generated from renewable sources like solar, wind and geothermal, electricity is consumed as it is produced. Electrolysis involves passing an electric current through water (H2O), which causes it to split into hydrogen (H) and oxygen (O). This process can be carried out either through an energy grid or on-site. Separated hydrogen may then be stored in a pressurized tank for future use. Stored hydrogen can be subsequently sent to fuel cells where it is recombined with oxygen and converted to a usable source of power for a variety of uses such as for generating heat or fueling transportation. Using renewable electricity can reduce dependence on fossil fuels and extend the reach of wind and solar power beyond the confines of the electric grid.

Renewable hydrogen is a viable and important solution for current and future energy problems. It is a source of zero carbon renewable energy that can supply the electricity used in the electrification of the transportation/mobility sector in lieu of petroleum based liquid fuel. Renewable hydrogen be injected into natural gas pipelines to decarbonize natural gas grids and downstream power plants, provide high quality heat required in factories (such as cement plants to reduce usage of coal and coke), be used as reducing agent in steel mills to produce high purity iron. Furthermore, renewable hydrogen can be easily stored in large quantities as a source of renewable energy unlike the cumbersome bulk and inefficiencies of batteries.

What is needed is the large-scale production of renewable green hydrogen that can be accomplished efficiently and with minimal greenhouse gas emissions. As noted above, current methods for producing renewable hydrogen using 100% renewable power involves the electrolysis of water. This process however is not optimal for a variety of reasons. Importantly, the process is prohibitively expensive when conducted on a large scale due to the dependency on renewable power (which is oftentimes intermittent), and also due to the requirement of a high amount of electricity (approximately 62 kWh to generate 1 kg of H2). In addition, there is a substantial cost associated with the use of deionized water, approximately 8 gallons of deionized water is necessary for producing 1 kg of H2. Further, the capacities of currently available electrolyzers are inadequate as they are useful for small scale production only. It is possible that the price of H2 production from electrolysis may reduce over time with the building of large offshore wind farms, perhaps accompanied by decreased costs of electrolyzers when and if large scale systems are developed. In the meantime however, what is necessary are immediate solutions to satisfy current and future demands for low cost, green hydrogen; ideally, such solutions should be cost-effective, easy to implement and require minimal investment in the development of new infrastructure.

Viewed both from an economic and technical perspective, it should be recognized that gasification of abundantly available biomass and waste materials to produce renewable hydrogen could be a cost effective way to supply the hydrogen required for FCEV (fuel cell electric vehicles) and for several other uses. Indeed the overall thermal efficiency of converting hydrogen to electric energy required by an FCEV is three times higher than the burning of that liquid fuel to power the combustion engine vehicles used today. Utilizing hydrogen in this way may contribute significantly to global energy security.

Worldwide, increasing amounts of biomass, whether municipal or industrial biomass, agricultural residues or industrial byproducts etc., are either dumped or remain unexploited, while releasing methane in the atmosphere. The impact of methane is estimated to be 28 to 36 times more harmful to the environment than carbon dioxide over 100 years according to the EPA. Furthermore, due to poor waste management methods in the past decades along with polluting energy production technologies (such as burning coal) there are continual increases in carbon dioxide and greenhouse gases emissions resulting in worsening global life cycle assessment.

Biomass including waste is also burned in common incinerators, creating emissions of pollutants, including carcinogenic materials such as semi-volatile organic compounds (SVOCs), dioxins, furans, etc., which are products of low temperature combustion. For the last couple of decades, developed nations such as the United States, Japan and European countries have been recycling their mixed plastics and mixed paper, totaling over 100 million tons per year, most of which are then exported to China for reuse in lower value products. This practice was halted by the Chinese government as of Jan. 1, 2018 resulting in millions of recycled materials being stored and/or sent back to landfills.

The need for systems and processes which include devices and apparatuses to handle and treat various forms of waste, biomass and recycled materials such as mixed plastics and mixed papers as well as converting these feedstocks into renewable synthetic gas to serve as a source of readily renewable electrical energy, has been met in part by the apparatus and processes disclosed and claimed in U.S. Pat. Nos. 5,544,597 and 5,634,414 issued to Camacho. These patents disclose a system in which biomass or other organic material is compacted to remove air and delivered in successive quantities to a reactor having a hearth. A plasma torch is then used as a heat source to pyrolyze organic components, while inorganic components are removed as vitrified slag.

More recently, improvements to the apparatus and processes of the above patents for pyrolysis, gasification and vitrification of organic material, was disclosed in U.S. Pat. No. 6,987,792 to Do et al. This patent provides an improved material feeding system in order to enhance further the efficiency of the process as well as to increase the flexibility of the system, increase the ease of use of the material handling system, and allow the gasifier to receive a more diverse and varied material stream.

The apparatus and process of U.S. Pat. No. 6,987,792 ensures that high temperature is maintained in the bed zone through the use of plasma torches in conjunction with a catalyst bed. Additionally, the patent discloses several rings of tuyeres designed and located at different elevations of the bed to inject, for example, oxygen enriched air from the sides of the reactor to its center in order to maintain high temperatures and an efficient and complete gasification condition along the overall cross sections of the gasifier, while observing sub-stoichiometric conditions. The oxygen utilized in the U.S. Pat. No. 6,987,792 is supplied by a secondary source and is not produced integrally within and by the system.

Though the previously described systems and processes are useful, they represent early attempts for biomass gasification for purposes of production of renewable power and renewable liquid fuels rather than for renewable hydrogen production. As described above, current energy demands and fuel-based industries require access to green renewable hydrogen and renewable energy in an increasingly cost-effective and time efficient manner.

What is needed therefore, are efficient systems, processes and methods for the gasification of biomass to produce renewable green hydrogen such that the hydrogen is available for use, for transportation, and for other industrial applications. Preferably such systems, processes and methods should be easy to implement, cost-effective, efficient, reliable and compatible with the energy needs of the modern world.

### SUMMARY OF THE INVENTION

Provided herein are methods, devices and systems for one stage plasma-enhanced gasification of biogenic hydrocarbon waste material comprising the use of novel gasification units and systems. As contemplated herein the gasification units and systems of the invention comprise: unique geometric designed shaped reactors having an upper plenum section and a lower double bed section, wherein the lower double bed section comprises a first, wider portion connected by a frustoconical transition to a second, narrower portion, and being suitable to receive a biochar carbon catalyst bed; wherein the upper plenum section has at least one or more gas exit ports; wherein a gas inlet system is disposed around said lower double bed section to provide oxidizing gas agent generated by an oxygen absorber system (such as a low cost oxygen (LCO) absorber system) into said lower double bed section through one or more intake ports in said lower section; and a plurality of inlets or tuyeres where plasma arc torches are mounted in said lower section to enhance the heat of oxidation generated from the said biochar carbon catalyst bed and said biogenic hydrocarbon waste material to create an operating temperature of 3000 to 5000 degrees Celsius. The integrated oxygen absorber system is designed to provide oxidizing agents in the form of atmospheric pressured oxygen enriched air, oxygen or steam to generate an autothermal exothermic oxidation of the biogenic hydrocarbon waste materials, introduced into the reactor.

In previous embodiments of the gasifier system as described in U.S. Pat. No. 6,987,792, oxygen was provided by a secondary source, such as an over the fence supplier, at very high costs. In certain previous embodiments, oxygen was provided by a dedicated air-separation unit using cryogenic technology, a methodology which again was significantly costly resulting in high energy consumption. In general, because the step of supplying oxygen was separate from the overall process, the additional steps required in sourcing the oxygen, introducing it into the system, monitoring and managing the operational aspects of this process, resulted in inefficiencies as well as elevated costs. In an effort to eliminate the aforementioned deficiencies, and in an effort to create streamlined, cost-effective and operationally superior systems and processes, the novel invention as described herein provides the unique feature which comprises the integration of an oxygen absorption mechanism into the gasifier.

The step of introducing oxygen from a separate source/location into the plasma gasification system is one that was described in previous patents and publications and routinely implemented in analogous devices. However, no prior art references, or systems disclosed or suggested the feature of actually integrating an oxygen absorption system directly into the gasifier. The concept of integrating an oxygen absorption system was neither envisioned nor reduced to practice until the creation of the invention as discussed herein. As such the features described herein are both novel and unobvious.

As described above, significant advantages are achieved by integrating an oxygen absorption system into the described plasma-based gasifier. First the integrated feature allows for oxygen to be produced at low pressure, requires minimal manual or operational interaction, and accordingly results in a consistent output with ultimately lower costs. Furthermore, an oxygen absorption system according to the invention can be configured to generate steam which can be injected along with the oxygen enriched air to produce high purity renewable hydrogen.

The novel embodiments provided herein, comprise an oxygen blown process for producing renewable hydrogen enhanced by the external source of heat generated by plasma torches (allothermal process) producing an outlet syngas containing mainly hydrogen and carbon monoxide. Hydrogen and carbon monoxide are two molecular compounds which are most stable at high temperature; and accordingly, as a result of the high temperature gradient generated in the gasifier wherein the hottest temperature is found at the lowest oxidation zone and rising to the top plenum area, these molecular compounds are found in the plenum area where all residual hydrocarbon chains are further thermally cracked near the top of the gasifier before they exit. In certain embodiments of the invention, the high temperature gradient generates approximately five zones.

In accordance with the methods described herein, syngas is reliably produced from various organic hydrocarbon-feedstocks and is substantially free of tars or polycyclic aromatic hydrocarbons (which are normally generated by lower temperature autothermal gasification systems). The biomass derived syngas generated under atmospheric pressure in the gasifier is subsequently drawn out with a blower system, scrubbed of impurities and acid gases, and then cooled down to a lower temperature, in the process generating high pressure steam. The high-pressure steam heat is then used to maintain the temperature of the integrated oxygen absorber system which operates around 450 degrees Celsius to 550 degrees Celsius. The absorption process is an exothermic process, while the desorption process of oxygen is endothermic and therefore the process runs on equilibrium without requiring increasing significant heat transfer from the gasification reactor. The resulting scrubbed, cleaned and cooled syngas (which consists of approximately >65 vol. % H2 and <35 vol. % CO) is then compressed and fed into a water gas shift system together with pressurized water vapor to convert most of the CO and H₂O into additional H2 and CO2. The off gas of the water gas shift reactor (if done with a one stage shift reaction which has a typical efficiency of 85%) contains mostly hydrogen gas and a much smaller volume of CO and CO2 and still contains sulfur containing compounds such as hydrogen sulfide, such as H2S, and carbonyl sulfide (COS) and other impurities, will be further compressed before being processed in a pressure swing adsorption (PSA unit). The PSA is the industry standard process technology for purifying hydrogen at industrial scale. In the PSA unit, the hydrogen is recovered and purified at a pressure close to the feed pressure, while adsorbed impurities are removed by lowering the pressure. Though not wishing to be bound by the following theory, the technology relies on differences in the adsorption properties of gases to separate them under pressure, and is an effective way of producing very pure hydrogen (up to 99.9999 vol. % purity). The entire process is automatic and utilizes the most advanced adsorbents on the market with patented cycles that are optimized for recovery and production of hydrogen. The PSA units are traditionally made for outdoor and unmanned operation and are designed to be both compact and fully skid-mounted. The PSA tail-gas, which contains impurities, can then be sent back to the fuel system even without a tail-gas compressor for use as a fuel gas to produce electric power in a series of small gas engines or microturbines. The power generated by the gas engines from the PSA off gas will be used to provide the parasitic power needs of the facility including the plasma torches, the compressors and pumps of the plant. The automatic PSA process resulting in the production of substantially pure H2 is compatible for use with polymer electrolyte membrane (PEM) fuel cell systems (such as those used in transport vehicles). In an embodiment, renewable hydrogen produced via the PSA system is then further compressed to 550 bar pressure and stored in custom designed storage tankers for hydrogen, ready for transportation to hydrogen utilities such as hydrogen refueling stations. Any carbon dioxide that is generated from the process is biogenic and can also be recovered as by-product for sale as food grade carbon dioxide, for sequestration (or alternatively it may be released into the atmosphere without any carbon penalty because it is biogenic carbon).

A significant solution to the deficiencies of the prior art and earlier patents is the integration of an oxygen absorber system, such as a “low cost oxygen” (LCO) system into the gasifier system to provide necessary oxygen-enriched air for the processing of biomass feedstocks while also reducing operational costs. Integrating the unique absorbing system to produce low pressure oxygen-enriched processed air, and using the exit gas heat to maintain the temperature of the isothermal absorber system at approximately 550° C. significantly lowers the operating costs of generating oxygen as compared to the high pressure oxygen delivered with an air separation unit (ASU) system, as well as significantly reduces the plasma torch power required to generate the required operating temperature of the gasifier, while optimizing the production of high purity hydrogen.

The apparatus described and referred to as a plasma-enhanced gasification system, contains one or more intake ports in the lower section where oxidizing agents such as air, enriched air with 90% to 95% oxygen, or steam is injected into the gas inlet system. The mode and quantity of oxidizing agent administration is determined according to the composition of the feedstocks, the volume of the feedstocks, the desired amount of hydrogen to be produced, and according to proprietary operational parameters to be designed and installed into the gasifier digital control system (DCS). The gas inlet system is integrated with a low cost oxygen absorbent system to provide only oxygen-enriched air or, in combination with steam, to assist in the oxidation and partial oxidation of the feedstock to enhance the amount of hydrogen produced in the synthetic gas output. A plurality of plasma arc torches is mounted in the lower section to heat the catalyst bed made up of a biochar material upon which the material being processed will be delivered on top creating a separate bed of feedstock materials. The catalyst bed helps distribute the heat evenly across the cross section of the apparatus preventing any channeling or bridging inside the fixed bed of feedstock materials above.

Another aspect of the present disclosure relates to methods for the conversion of material comprising waste, biomass or other carbonaceous material by plasma-enhanced thermocatalytic gasification into renewable hydrogen, wherein the methods comprise providing a carbonaceous biochar material to serve as a catalyst bed instead of using metallurgical or petroleum coke material in the oxidation zone section of a reactor. The biochar material comprises a dense carbon char material made from the pyrolysis of woody biomass (including but not limited to coconut shells) and further compressed into a char product which is denser and which consumes at a much slower rate than the biomass feedstocks to be gasified due to the very high fixed carbon fraction of the former. The biochar catalyst, beyond serving as a consuming bed to support the feedstocks and to distribute the plasma heat across the cross section of the reactor, also provides a way to enhance the calorific content of the feedstocks as well as to allow for the flow of the molten inert materials through the porosity of the catalyst bed. The production of the biochar to meet the specifications required for the plasma-enhanced gasification system described herein, comprises both a unique and novel proprietary process, one that is distinct from standard coke catalysts produced from fossil fuels.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an elevation view of a prior art apparatus.

FIG. 2 is an elevation view of a gasifier used with an embodiment of the present disclosure.

FIG. 3 is a graph of pressure drop versus diameter size of the feedstock employed according to the present disclosure.

FIG. 4 is an elevation partial view of a gasifier used with an embodiment of the present disclosure illustrating representative pressure and temperature sensors.

FIGS. 5A-5C are cross-sectional views of FIG. 4 illustrating location of representative pressure and temperature sensors. FIG. 5D illustrates Process Connection Location (instruments and angle). [Note: all dimensions are in degrees to the centerline of the nozzle, each type of instrument nozzle is spaced equidistantly around the SPGR circumference, and the number of instrument nozzles show is for illustration purposes only.]

FIG. 6 proves a schematic depicting certain components of one embodiment of an oxygen production module.

FIG. 7 proves a schematic depicting an integrated oxygen production for IGCC with a reciprocating engine and CO2 capture. Oxygen production module (LCO) as schematically shown earlier in FIG. 6 is immersed in a syngas “cooler”.

FIG. 8 provides a flow diagram demonstrating the role of renewable hydrogen produced by the methods described herein in the iron and steel industry.

FIG. 9 provides a recommended configuration of the inventive plasma-gasification process for cement.

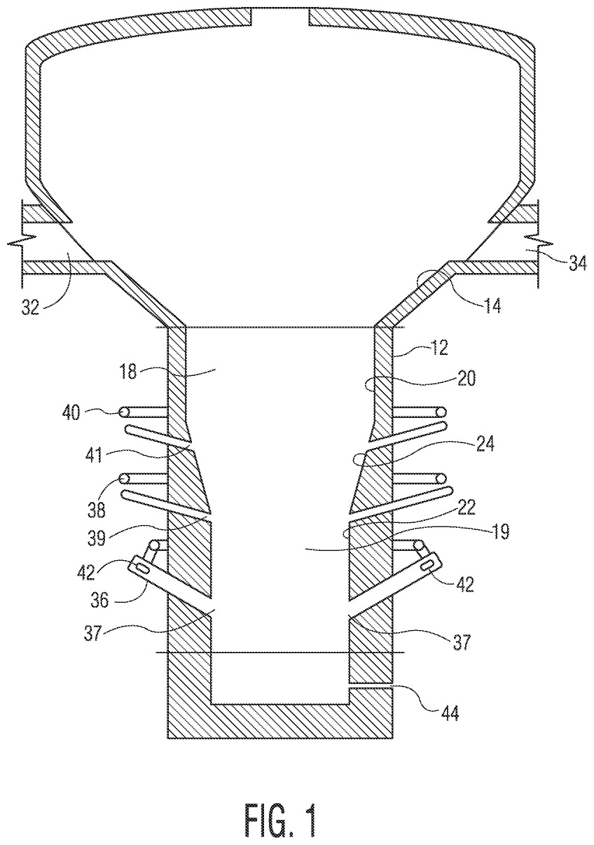

### DETAILED DESCRIPTION

The present invention is described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. One skilled in the art will recognize that the systems and devices of embodiments of the invention can be used with any of the methods of the invention and that any methods of the invention can be performed using any of the systems and devices of the invention. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as would be commonly understood or used by one of ordinary skill in the art encompassed by this technology and methodologies.

Texts and references mentioned herein are incorporated in their entirety, including U.S. Pat. Nos. 5,544,597, 5,634,414, 6,987,792, PCT/US14/15734, U.S. patent application Ser. No. 13/765,192, PCT application filed PCT/US14/15792, and U.S. Pat. No. 9,206,360.

The novel invention provided herein comprises devices, systems, and methods of using the same, that enable gasification of materials, such as biomass, to produce hydrogen gas. As contemplated herein, the term biomass is intended to encompass any biomaterial and is used interchangeably with the term feedstock. In certain embodiments, biomass may include, but is not limited to, waste, re-cycled paper, organic waste, purposely grown energy crops, wood or forest residues, waste from food crops, horticulture, food processing, animal farming, human waste from sewage plants or industry waste.

At least one advantage of the invention is that the use of biomass provides the benefits of both reducing greenhouse gases and carbon footprint by producing a biomass derived syngas (bio-syngas) for the production of renewable hydrogen and biogenic carbon dioxide. The produced renewable hydrogen and biogenic syngas can be further processed to produce renewable power through a variety of methods and devices known to those skilled in the art, including but not limited to, hydrogen fuel cell batteries, proton exchange membrane fuel cells (PEM FC) or solid oxide fuel cells (SOFC) providing a complete off grid distributed renewable power system to facilities, vehicles, and the like that require energy. The renewable hydrogen and biogenic carbon dioxide produced herein can also be recombined through a mechanization process to produce renewable methane gas for use in gas pipelines instead of natural gas. Lastly, the renewable hydrogen and/or biogenic carbon monoxide can be use as feed gas to create transportation fuels such as ammonia, synthetic methane a.k.a. renewable natural gas (RNG), renewable methanol, synthetic paraffinic kerosene and renewable liquid fuels to replace gasoline and diesel in the transport sector. Furthermore, the methods and processes described herein may work with any organic hydrocarbon containing waste material.

In certain embodiments of the invention, the hydrogen generated according to the methods described herein may be delivered to a fueling station by truck or pipeline under pressure as compressed hydrogen gas, and stored at suitable conditions (most typically in one or more underground storage tanks. Hydrogen is then withdrawn from the storage tank/tanks in continuous manner or on demand and recompressed to the desired pressure required by the fuel cell vehicles as required.

Gasifier

A typical one stage atmospheric pressure thermocatalytic plasma enhanced gasifier integrated with LCO (low cost oxygen) absorber system used in accordance with the invention may be configured to process from 5 to 20 metric tons per hour of mixed sources of organic waste and/or biomass, although gasifiers sized larger or smaller may be used. The exact throughput will depend on the composition of the feed material and the desired overall throughput of the generating plant. The gasifier of the present disclosure can be distinguished from other plasma gasification reactors by the fact that it is integrated with an oxygen absorber system, such as a LCO oxygen absorber system, with both systems operating at about atmospheric pressure or slightly below atmospheric pressure and high temperature (greater than 1,200° C. for exit gas temperature) to ensure that there are no unconverted hydrocarbon molecules such as tars in the syngas product. The novel one stage allothermal plasma enhanced gasification processing system integrated with LCO oxygen absorber system is unique because, as opposed to other biomass gasification systems, it produces a syngas having a high hydrogen volume concentration which is also substantially free of tar; as a result the syngas does not additional processing in a secondary syngas cracking chamber (typical of lower temperature autothermal gasifiers).

An additional novel feature of the invention includes an embodiment wherein the gasifier comprises a unique biochar catalytic bed. The thermocatalytic plasma gasification processes include the ability to continuously control and monitor the unique biochar catalytic bed composition dimensions (namely height). In an embodiment, the biochar comprises mainly carbon derived from char generated from biomass pyrolysis. Additional materials are mixed with the biochar into the gasifier such as flux materials comprising silica and calcium oxide (typically in the form of limestone). The composition of the biochar is customized to address specific gasification/vitrification process operating conditions.

In an embodiment, the biochar carbon catalyst bed is designed and to ensure consistent plasma heat distribution across the cross-section of the reactor as a result of its high fixed-carbon content in contrast to the high volatile matter content of the feedstock (biomass and waste materials). In contrast to currently available fixed bed gasifiers, the biochar carbon catalyst even heat distribution helps prevent the channeling of heat through the feedstocks bed or the formation of melted frozen plug (dead body plug) within the feedstocks typically encountered with fixed bed gasifier. Furthermore, the biochar carbon catalyst serves as a consuming bed supporting the feedstocks charge bed above, and providing interstitial space for molten flux, slag and inorganics such as metals to flow downward and for ashes to flow upward. Silica and calcium oxide (in the form of limestone) are used to maintain the proper pH which determines the lava pool chemistry and viscosity, prior to being tapped out of the reactor. The biochar catalysts, along with the flux materials are continuously fed together with the feedstocks prior to being delivered into the gasification reactor through a specific feeding system in such a way that the carbon to silica to calcium oxide ratio (C:SiO:CaO) optimizes the gasification operating conditions.

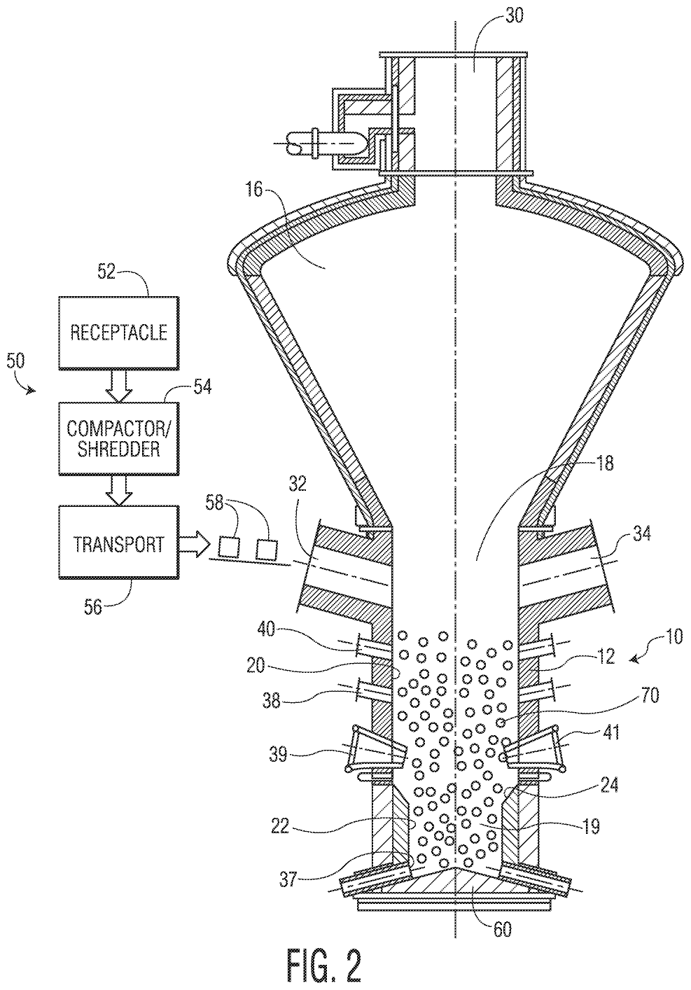

As shown in FIG. 2, gasifier 10 is constructed preferably of high-grade steel. The gasifier has a refractory lining 12 throughout its inner shell. In certain embodiments, the upper two-thirds of the gasifier is lined with up to one to ten layers of refractory material and preferably three layers, with each layer in the range of about 1 to 20 inches, or about 4 to 6 inches thick or about 10 to 14 inches thick. Specifically, the dome of the plenum area is covered with high alumina monolithic refractory. The plenum zone is lined with high alumina brick in the hot face layer and high alumina brick in the backing layer as well. The middle area the feedstock bed and the biochar catalytic bed are lined with high chrome brick in the hot face layer, and high alumina brick in the backing layer. Typically, the lower third of the gasifier is lined with up one to ten layers of refractory brick, and preferably three, for a total thickness of about 20 to 30 inches. The lava slag alone will be lined with high chrome brick in the hot face layer and silicon carbide brick in the backing layer. Depending upon the application other refractory configurations may be used. Both sections utilize typical commercial refractory products, which are known to those in the reactor industry.

The gasifier 10 has a specific geometric shape throughout its vertical length which is designed according to the superficial velocity of the gas inside the gasifier. Proprietary calculations are used to create the shape of the reactor and the refractory lining in order to ensure that the superficial velocity of the rising hot gas from the lower oxidation zone and the gas inlet remain below a specific threshold of meters per second. The specifically calculated superficial velocity of the gas ensures that the feedstock materials will descend into the lower gasification zone of the reactor and not be elutriated or blown out into the exit gas unprocessed, which in turn can cause plugging and clumping into the syngas exit duct. The top third wider portion of the gasifier is referred to as the thermal cracking plenum zone 16 and sized to allow sufficient residence time of the exit gas to be completely thermally cracked. Typically, the hot syngas exits the gasifier through a single outlet 30 in the center of the top of plenum zone 16. Alternatively, a plurality of exit gas outlets may be provided around the top of zone 16.

Middle section 18 of the gasifier, also called the double bed zone, is defined by a side wall 20 having a circumference smaller than that of the plenum zone 16. In the upper part of the section 18 and above the catalyst bed are two opposing feed biomass inputs 32 and 34, although the gasifier may be designed with additional biomass inputs. Typically, the inputs 32 and 34 are located in the upper 50% and more typically in the upper 20% of section 18. Also, the inputs 32 and 34 are typically at an angle of about 45 to about 90 degrees and more typically at an angle of about 60 to about 85 degrees relative to the vertical axis of the gasifier 10. Section 18 is also encircled by two or more gaseous oxidant rings (not shown) which is connected to an integrated oxygen absorber system whereby a combination of air, oxygen enriched air and or steam at proprietary percentage would be injected into the reactor. Each ring injects, for example, oxygen-enriched air and/or oxygen in the bed zone (as predetermined according to the biomass composition), through equally spaced inlets, called LCO tuyeres, 39 and 41. Additionally, the integrated LCO oxygen absorber system is also connected to the primary plasma torch tuyeres, referenced as 36 and 42, whereby the oxidizing agent including oxygen enriched air are injected simultaneously with the firing of the plasma plumes from the torches to ensure complete ignition of the biochar carbon catalyst bed and maintaining a constant heated bed across the cross-section of the reactor bottom. The number of primary tuyeres, which house non-transferred plasma arc torches, typically ranges from two to six. The number of gas tuyeres may typically range from six to ten depending on the size of the gasifier and the throughput of the system, although a larger or smaller number may be used.

The number of gaseous oxidant rings may typically range from one to twenty, one to fifteen, one to ten or two to three depending on the catalyst and biomass bed height; although a larger or smaller number may be used. Concerning the oxidant, nitrogen is considered an inert molecule in the syngas and therefore does not contribute to any process located downstream of the gasification reactor, including chemical synthesis or electricity production. Furthermore, the more nitrogen there is in the syngas—or inert to a further extent—the larger is the volume of syngas to process in subsequent systems. As a consequence, since there is no commercially available system to remove nitrogen from syngas, large systems located downstream of the one stage thermo-catalytic gasification reactor would be needed to handle the syngas which therefore would raise the facility's capital expenditure.

Since air is composed of primarily nitrogen (79% v/v) and oxygen to a lesser extent (21% v/v), air per se is not a preferred oxidant because an objective of the present disclosure is to reduce nitrogen content in the syngas. Similarly, enriched-air has sufficiently high oxygen content (typically at least about 80% and more typically at least about 95%) to be qualified as a viable oxidant agent. The table below provides a comparison of syngas composition and volume for two different levels of air enrichment.

| | Scenario 1 | Scenario 2 |
|---|---|---|
| | Enriched air | Enriched air |
| | composition | composition |
| | N2 = 1%; | N2 = 50%; |
| | O2 = 99% | O2 = 50% |
| Syngas temperature (° C.) | 1,223 | 1,248 |
| Syngas volume (Nm³/hr) | 30,535 | 36,531 |
| Syngas low heating Value (kJ/kg) | 10,070 | 7,274 |
| Syngas composition at reactor outlet | | |
| (mol. % v/v) | | |
| H₂O | 16.40 | 15.74 |
| CO | 39.95 | 32.40 |
| CO₂ | 7.65 | 7.39 |
| N₂ | 3.23 | 19.11 |
| H₂ | 32.67 | 25.29 |

As expected, the volume of syngas is significantly decreased. In this particular example, it is decreased by 20% if the level of oxygen purity in the enriched air increases from 50% to 99%. In addition, the heating value of the syngas increases with the level of oxygen enrichment. In this particular example, the heating value increases by 40%. As discussed herein, the present disclosure providing an integrated LCO oxygen absorber (to provide low cost atmospheric oxygen enriched air) further reduces the costs of downstream handling of excess nitrogen in the syngas as well as reduces the specific energy requirements of the plasma torches to further optimize the production of renewable hydrogen. In general, a level of oxygen purity equal to or greater than 95% v/v is preferred.

The bottom third of the gasifier is vitrification zone 19, which is defined by a side wall 22 having a circumference smaller than that of zone 18. Side walls 20 and 22 are connected by a frustoconical portion 24. Vitrification zone 19 houses one or more tap holes where molten slag liquid is tapped continuously typically into a refractory lined hot launder. The hot launder discharges into a cold launder where the slag is quenched via direct contact with cold water sprays prior to flowing into a slag quench tank. The granulated slag is collected via an inclined conveyor in the quench tank which discharge directly into weigh skips where it is collected and stored prior to moving to a dedicated storage area. Water from the quench tank flows via a high level into a settling tank feeding water recirculating/spray pumps. The intent of the system is for a continual flow of slag through the slag tap holes. A dedicated tap hole burner is located adjacent to each tap hole in order to combust any syngas which may be emitted during slag-tapping operation. The inert slag material suitable for re-use as construction material. Construction materials with which this slag may be used include tile, roofing granules, and brick. This bottom section of the gasifier, which contains the molten slag, may, in certain configurations, be attached to the gasifier via a flanged fitting to enable rapid replacement of this section in the event of refractory replacement or repairs.

Each non-transferred plasma arc torch plugged in primary tuyeres 39 and 41 is generally supplied with electric power, cooled deionized water and plasma gas through supply conduits from appropriate sources (not shown). The number of torches and primary tuyeres, the power rating of each torch, the capacity of the biomass feeding system, composition and amount of the biochar carbon catalyst, the amount of catalyst, the oxygen-purity of the oxidant, the amount of oxidant, the size and geometry of the gasifier, the size and capacity of the syngas cooling, cleaning, compressing and conditioning systems are all variables to be assessed according to the type and volume of biomass to be processed by the system. There are typically at least 3 and more typically at least 4 plasma torches around the circumference of the reactor 10.

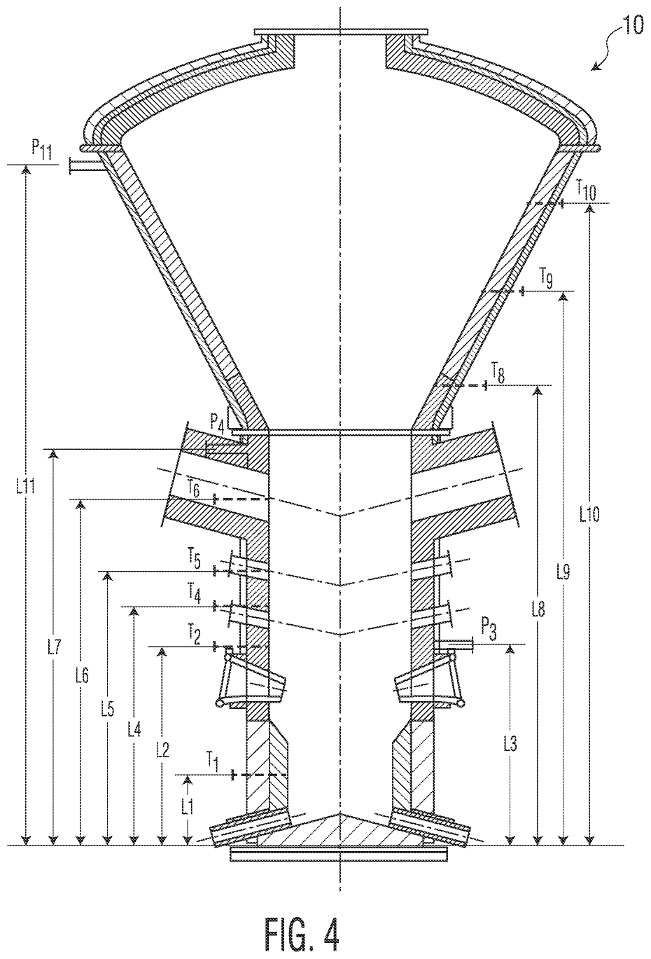

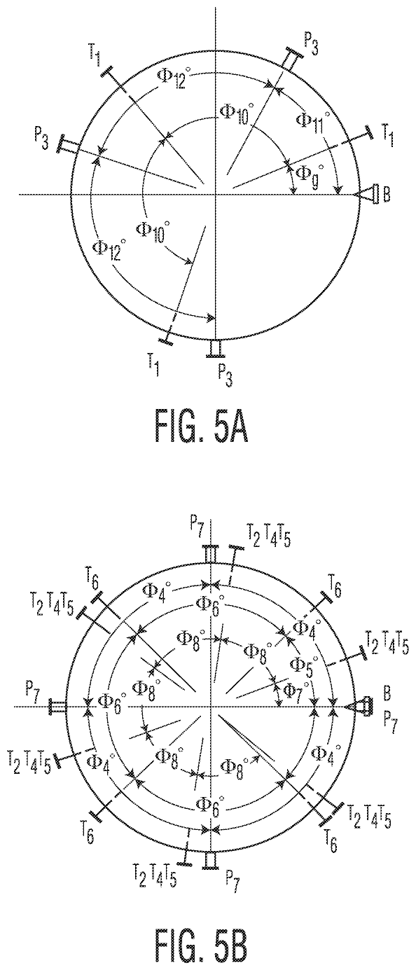

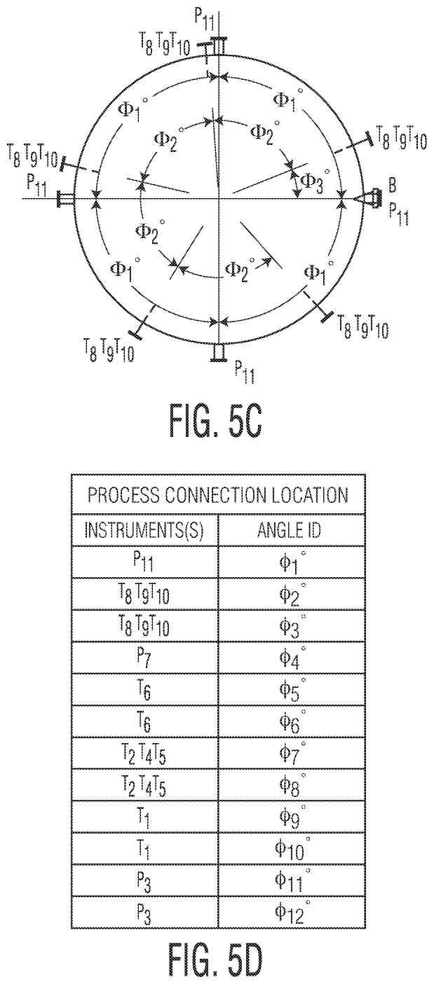

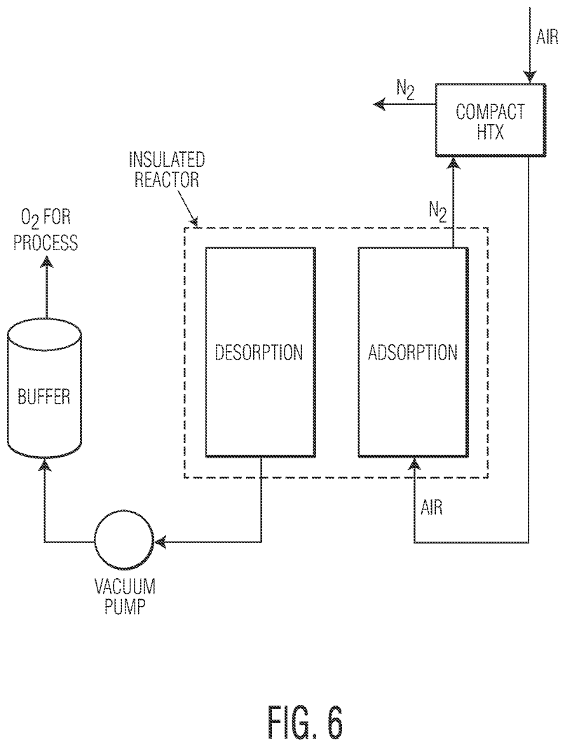

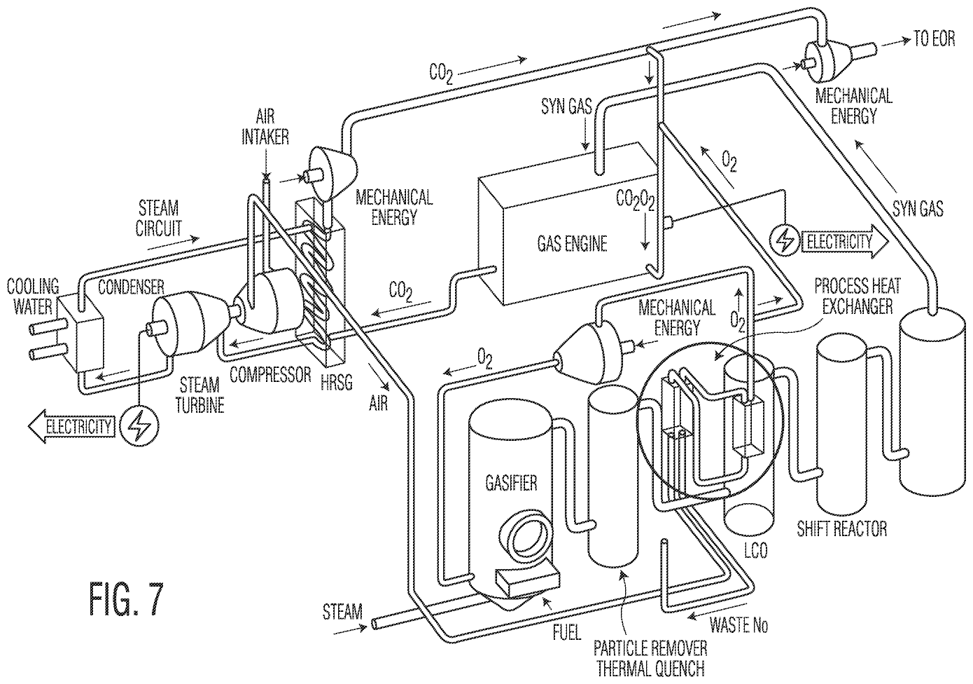

The gasifier will typically contain throughout its shaft at intervals of about three feet or less, sensors to detect the pressure and temperature inside the gasifier, as well as gas sampling ports and appropriate gas analysis equipment at strategic positions in the gasifier to monitor the gasification process. The use of such sensors and gas analysis equipment is well understood in the art. See FIG. 4, which is an elevation partial view of gasifier 10 illustrating representative pressure sensors P3, P4 and P11 and temperature sensors T1, T2, TT4, T5, T6, T8, T9 and T10. Also, see FIGS. 5A-5C which are cross-sectional views of FIG. 4 illustrating location of representative pressure sensors P3, P7 and P11 and temperature sensors T1, T2, TT4, T5, T6, T8, T9 and T10. The nozzles of the sensors are spaced equidistantly around the circumference of the gasifier. The number of the nozzles of the sensors and types of sensors shown is for illustration purposes only.

Biomass and Biomass Feeding System

A compacting biomass delivery system operating through hydraulic cylinders and/or screws to reduce the biomass volume and to remove air and water in the biomass prior to feeding into the top of the bed zone as previously described and disclosed in the above identified Solena Fuels Corporation patents can be employed.

In order to accommodate biomass and biomass-residues, as per its definition by the UNFCC.sup.1, organic renewable feed stocks biomass from multiple and mixed sources such as RDF (refuse-derived fuel), loose municipal solid waste (MSW), industrial biomass, and biomass stored in containers such as steel or plastic drums, bags and cans, a very robust feeding system can be used. Biomass may be taken in its original form and fed directly into the feeding system without sorting and without removing its containers. Biomass shredders and compactors capable of such operation are known to those of ordinary skill in the field of materials handling. Biomass feed may be sampled intermittently to determine its composition prior to treatment.sup.1 http://cdm.unfccc.int/Reference/Guidelarif/melbiocarbon.pdf

Biomass includes, but is not limited to, non-fossilized and biodegradable organic material originating from plants, animals and micro-organisms. This shall also include products, by-products, residues and waste from agriculture, forestry and related industries as well as the non-fossilized and biodegradable organic fractions of industrial and municipal wastes. Biomass also includes gases and liquids recovered from the decomposition of non-fossilized and biodegradable organic material. (b) Biomass residues means biomass by-products, residues and waste streams from agriculture, forestry and related industries.

In U.S. Pat. No. 6,987,792, it is mentioned that the compacting system shall be nitrogen purged. One of the reasons for having a nitrogen purged system, instead of air, is to avoid that the screw gets back-fired as it conveys feedstock towards the reactor. It is crucial that the system be purged with an inert gas, although not necessarily with nitrogen. The advantage of using nitrogen is that it is not expensive to produce. On the other hand, the main downside is that it increases the amount of nitrogen in the gas of synthesis (other sources of nitrogen are the air going through the plasma torch system and the nitrogen contained in the feedstock).

According to the present disclosure, an alternative to nitrogen as a purging agent is carbon dioxide. Although it will inevitably increase the amount of CO₂ in the syngas, off-the-shelf systems are commercially available to extract carbon dioxide from a syngas—unlike nitrogen—such as a Rectisol, Selexol or an amine unit. This alternative is particularly relevant in a scenario where a CO₂ removal unit would have to be used in any case, as it now provides a cheap alternative to decrease inert content in syngas.

All the biomass and organic material, optionally including the containers in which it is housed, is crushed, shredded, mixed, compacted and pushed into the plasma reactor as a continuous block of waste by a system (not shown). The biomass can be comminuted to a preset size to insure optimal performance of the gasifier. The feeding rate can also be preset to ensure optimum performance of the gasifier.

Typically the organic material injected into the reactor has a physical size not less than about 2 cm in diameter to avoid pressure drop effect. Similarly, its size typically does not exceed 5 cm in diameter to ensure that the bed height does not exceed a specified maximum, thus limiting the height of the reactor's shaft.

For example, the pressure drop across the bed would be about 900 Pa/m if the particle size were 1 cm in diameter; whereas, it is only 10 Palm with a particle size of 5 cm in diameter. However, bed heights vary as a function of particle size and the bed height would be about 0.5 m if the particle size were 1 cm in diameter; whereas, it is 2.5 m with a particle size of 5 cm in diameter. Therefore, the overall pressure drop would be respectively 400 Pa and 25 Pa.

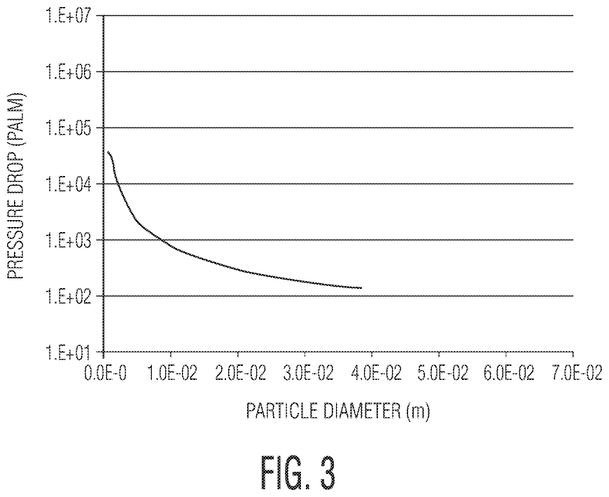

Therefore particle size and to a further extent pressure drop have significant impact on the design, and thus cost, of the induced draft located downstream of the reactor to extract the syngas. Consequently, the bigger the particle size is, the less pressure drop occurs, but the higher is the bed height. As shown in FIG. 3, it has been determined according to the present disclosure that the optimum particle size is about 3 to about 5 cm in diameter. Particle sizes exceeding 5 cm in diameter would certainly have as a consequence an increase in the height of the shaft of the reactor.

The blocks of biomass are delivered into the gasifier continuously from multiple locations in zone 18 of the gasifier, ensuring even distribution in the gasifier until a specific biomass bed height is achieved above the consumable biochar carbon catalyst bed. Two blocks of biomass may be fed simultaneously into input chutes provided at diametrically opposite sides of gasifier 10. More than two chutes may be provided to accept additional blocks. Any arrangement is suitable, so long as it avoids an uneven build-up of biomass in any one location in zone 18 of the gasifier.

The lifetime of the refractory materials and thus the reactor operating conditions as well are enhanced by injecting the organic feedstock into the upper part of the bed zone 18 instead of upper section 16 of the gasifier. To further protect the refractory, the use of the inventor's proprietary biochar carbon catalyst once gasified will provide an internal layer of carbon bio char to further protect the hot face of the refractory in the double bed zone.

In addition, for reliability purposes, a reactor should typically house at least two (2) feeding systems for the biomass feedstock and at least one (1) feeding system for the biochar carbon catalyst material. This is due to the fact that catalyst material cannot be compacted with biomass material due to their different densities, and because we want to maintain a certain size to our bio char carbon catalyst to allow the porosity we require in the biochar carbon catalyst bed

Pressure sensors and temperature sensors along the gasifier, as well as microwave sensors on top of the gasifier, can be used to measure bed height and control the feeding rate of the biomass. As a back-up, sight ports may be provided at certain locations to verify activities inside the gasifier. All information from the sensors will be fed into a digital control system (DCS) that coordinates the operation of the whole plant performance. The coordination and monitoring of the feeding system through the use of sensors and a DCS as part of the process control of the gasifier are normal protocol and readily apparent to those skilled in the art.

Alternate configurations of the feeding system may be used for different materials. For instance, fine powders or liquid biomass may be injected directly into the gasifier. Gas transport may be used for fine solids, such as biomass fines including saw dust as well as direct injection of gas products such as biogas, renewable methane or natural as for production of Hydrogen. Standard pumps may be used for liquids. Such systems are well known to practitioners of material handling. At least one key advantage for the plasma enhanced oxygen blown gasifier system provided herein includes the ease of the feeding system due to the atmospheric pressure condition of the gasifier as compared to the standard autothermal pressurized and fluidized bed gasifier common in the industry.

Operation of the SPGV Reactor

The shredded and compacted biomass material 58 is fed by the feeding system continuously into gasifier 10. For the sake of simplicity, the continuous feeding from opposite sides of the gasifier ensures uniform distribution of the biomass feed across the cross section of the gasifier. The uniformity of the biomass feed distribution as it forms a biomass bed ensures the uniform, upward flow of hot gas from the plasma heated biochar carbon catalyst bed. The biochar carbon catalyst bed toward the bottom of the plasma gasifier is constantly heated by the plurality of plasma torch plumes uniformly distributing the heated gas and feedstock particles upward across the cross section of the gasifier. The heat and hot gas when distributed uniformly upward, heat and dry the down-flowing biomass feed and enable the gasification processes to occur efficiently. The uniform heat distribution upward and the presence of the biochar carbon catalysis bed also avoids channeling of the heat, which in turn prevents the bridging of the biomass feed, which is a typical problem encountered in other fixed bed thermal biomass treatment processes.

The gasifier's specific geometric funnel shape and the rising gas feed rate (from the torches and other gas inlets) are designed to ensure minimum and specific superficial velocity of the rising hot gases. This low superficial velocity allows the entering biomass feed to descend into the biomass bed completely and not be forced upward or elutriated into the exiting gas as unprocessed biomass or particulate carryover. Additionally, the plenum cracking zone 16 of the gasifier serves to ensure that all hydrocarbon materials are exposed to the high temperature with residence time in excess of 2-3 seconds prior to exiting the gasifier. This zone completes the thermal cracking process and assures complete gasification and conversion of higher hydrocarbons such as tars to CO and H₂.

As the cold waste feeds are continuously fed into the plasma-enhanced thermocatalytic gasifier and form a bed of biomass on top of a previously heated bed of consumable biochar carbon catalyst in the bottom of the gasifier, the descending cold waste and the rising heated gas from the consumable catalyst bed create a counter-current flow that allows the complete stages of reaction from oxidation, to partial oxidation to devolatilization and drying zones of the biomass uniformly across the reactor and its vertical zones.

The consumable biochar carbon catalyst bed applied and used in this process is not unlike that used in typical metallurgical blast furnaces, and its inclusion into the gasification process serves at least the following several functions: (1) it allows for the distribution of the plasma-generated heat uniformly across the plasma gasifier and thus prevents the excessive wear and tear in the refractory that is normally encountered when intense focal heat sources such as plasma torches are utilized; (2) it initiates the gasification reaction by providing the key component of the exit gas, i.e., the CO (carbon monoxide) contributing to the heating value of the exit top gas; (3) it provides a porous but solid support framework at the bottom of the gasifier upon which the biomass bed can be deposited; (4) it allows the hot gaseous molecules to move upward into and through the biomass bed uniformly, while allowing the inorganic material in the biomass such as metal and ferrous to be melted and to flow downward into the molten pool at the bottom of the gasifier; and (5) it provides a layer of protection inside the innermost refractory layer and thus decreases heat loss in the gasifier while extending the refractory life. The present disclosure comprises the unique utilization of a proprietary biochar carbon product to be used as the catalyst thus reassuring also that all gaseous products from CO, H2, CO2 are biogenic in nature and that the gas products are completely renewable and green.

In addition, the biochar carbon catalytic bed composition and height, whose purpose is multifold, are continuously controlled and monitored. First, its constituents are typically mainly carbon, and a small amount of ash to address specific gasification/vitrification process operating conditions. The high biochar carbon content is used to ensure the plasma heat distribution across the cross-section of the reactor due to its high fixed-carbon content in contrast of the high volatile matter content of biomass. Silica and calcium oxide referred together as flux are also added and are used to maintain the proper and adequate lava pool chemistry prior to being tapped out of the reactor. These catalysts are continuously mixed together prior to being injected into the gasification reactor through a specific feeding system in such a way that the biochar carbon to silica to calcium oxide ratio (C:SiO.sub.2:CaO) optimizes the gasification operating conditions.

The bed of biochar carbon catalyst is maintained by injecting catalyst typically at a rate of about 2% to about 10%, and more typically about 3% to about 5% of the biomass weight rate. It is constantly consumed at a slower rate than is the biomass bed due to its higher density fixed carbon content than biomass, higher melting temperature, and hard physical properties. The height of the consumable biochar carbon catalyst bed, like the biomass bed, is monitored constantly via temperature and pressure sensors located circumferentially around the gasifier and at various elevations along the shaft. As biomass bed and biochar carbon catalyst bed 70 are consumed during the process, the sensors will detect a temperature and pressure gradient across the gasifier and automatically trigger the feeding system to increase or decrease the bed height in a steady-state operation in order to maintain the optimum production of hydrogen.

The interaction of a carbon catalysis bed and molten material is a well-understood phenomenon. In the case of molten metal flowing over hot coke, as in the case of foundry cupola melters, the molten iron does not stick to the hot bed but flows over it. The same phenomenon is observed during the melting of non-metallic material, i.e., vitrification of slag. Unlike metal melting, slag vitrification does not involve dissolution of carbon since the solubility of carbon from the coke into the molten slag is negligible. At least one key difference between this invention and the prior art is the use of biochar carbon material to serve in lieu of using metallurgical coke or petroleum coke used in the metallurgical and blast furnace, to prevent and avoid the use of fossil fuels for the production of renewable hydrogen.

The hydrocarbon portion of the biomass is gasified under the partially oxidizing atmosphere of the gasifier in an oxygen-reduced (with respect to complete oxidation of carbon to CO₂) environment. Therefore, there is no combustion process occurring in the gasifier to produce the pollutants normally expected from incinerators, such as semi-volatile organic compounds (SVOCs), dioxins, and furans, which are carcinogenic compounds.

The controlled introduction of oxygen and/or oxygen-enriched air and/or steam which is produced by the integrated LCO Oxygen absorbent system, into the gasifier and which is enhanced by heat generated by the plasma arc torches can generate up to 4000 degrees Celsius inside the bottom of the gasifier to generate a controlled partial oxidation reaction of gasification will generate an optimal exit top syngas with higher calorific content, higher volume of hydrogen, while reducing the specific energy requirement, that is, the energy consumed by the plasma torches to gasify the biomass. This in turn results in a higher net efficiency from the gasification of organic biomass for the production of hydrogen.

The biomass bed is continuously reduced by the rising hot gases from the consumable biochar catalyst bed and continuously replenished by the feeding system in order to maintain the bed height. This sequence results in a temperature gradient from at least about 4000 degrees Celsius at the bottom of the gasifier to at least about 1200 degree Celsius in the exit syngas outlet. The rising counter-current system thus established serves to dry the incoming biomass and thus allow the system to handle a biomass stream with moisture content of up to 90% in the case that high moisture biomass is used without causing shutdown as in other thermal combustion system. Naturally, the high moisture content of the biomass feed would result in a syngas with lower heating value and less hydrogen production due to the lower hydrocarbon content of the biomass feed.

The gasifier typically operates at about atmospheric pressure or more typically slightly below atmospheric pressure due to the exit gases being constantly extracted out of the gasifier, for instance, by an induction fan (ID fan) or blower (not shown). As mentioned previously, the gasifier conditions are reducing to partial oxidation in nature, with mostly limited oxygen conditions suitable for the gasification process. The independent control variables of the process are (1) the biomass feed rate, (2) the consumable biochar carbon catalyst bed height, (3) the torch power, (4) the oxidant gas flow generated by the LCO Oxygen absorber system, and (5) the C:SiO₂:CaO mixing ratio of the bio char carbon catalyst material and the flux material considered in the process.

The molten, pool of inorganic material at the bottom of gasifier 10 is tapped continuously out of the gasifier via one or more slag tap 37 into refractory-lined sand boxes and cast into large blocks to maximize volume reduction, or into a water quenched launder to generate granulated slag materials as desired by the operator.

To ensure that the slag flow is uniformly constant and to prevent plugging of the slag tap hole 37, the temperature of the slag as reflected in the temperature of the gasifier bottom thermocouple system as well as the slag viscosity may be independently controlled by the plasma torch power and the amount of flux material such as limestone to have an optimal C:SiO₂:CaO ratio added through known relations. Lava pool height is also measured by the use of thermal sensors.

All these monitored parameters regarding the temperature, pressure, gas composition, and flow rates of gas and molten material are fed as inputs into a computerized DCS system, which in turn is matched to process controls of the independent variables such as torch power, air/gas flow, biomass and catalyst feed rates, etc.

Depending on the previously analyzed waste feed, specific gasification and vitrification conditions are predetermined and parameters pre-set by the DCS control system. Additional and optimizing conditions will be generated and adjusted during start-up of operation when actual biomass materials are fed into the system, which will be run with a unique computerized (artificial intelligence) program to continually adapt and optimize for the production of renewable hydrogen, and its downstream applications.

Operating Principles

In general, the plasma gasification-vitrification apparatus and process described herein functions and operates according to several main principles.

Variations in the biomass feed will affect the outcome of the process and will require adjustment in the independent control variables. For example, assuming a constant material feed rate, a higher moisture content of the biomass feed will lower the exit top syngas temperature; the plasma torch power must be increased to increase the exit syngas temperature to the set point value. Also, a lower hydrocarbon content of the biomass will result in reduction of the carbon monoxide and hydrogen content of the exit gas resulting lower high heating value (HHV) of the exit top syngas; the enrichment factor of the inlet gas and/or plasma torch power must be increased to achieve the desired HHV set point as well as the desired volume of hydrogen. In addition, a higher inorganic content of the biomass will result in an increase in the amount of slag produced resulting in increased slag flow and decreased temperature in the molten slag; the torch power must be increased for the slag temperature to be at its target set point. Thus, by adjusting various independent variables, the gasifier can accommodate variation in the incoming material feed while maintaining the desired set points for the various control factors. The present disclosure further includes the proprietary aspect that the above process algorithm will be controlled via a DCS system equipped with artificial intelligence (AI) allowing for the automatic adjustment and optimization of the process to maximize the production of renewable hydrogen and its downstream applications including the generation of synthetic methane or synthetic liquid fuels.

Start-Up

The goal of a defined start-up procedure is to create a gradual heat up of the plasma gasifier to protect and extend the life of the refractory and the equipment of the gasifier, as well as to prepare the gasifier to receive the biomass feed material. Start-up of the gasifier is similar to that of any complex high-temperature processing system and would be evident to skilled artisans in the thermal processing industry once aware of the present disclosure. The main steps are: (1) start the gas turbine on natural gas or biogas to generate electricity or using renewable electricity from the power grid; (2) gradually heat up the gasifier by using a renewable gas or biogas burner (this is done primarily to maximize the lifetime of the refractory material by minimizing thermal shock) and switch to plasma torches once suitable inner temperatures are reached; and (3) start the syngas clean-up system with the induced draft fan started first. The consumable catalyst bed 70 is then created by adding the material such that a bed is formed. The bed will initially start to form at the bottom of the gasifier, but as that initial biochar catalyst, which is closest to the torches, is consumed, the bed will eventually be formed as a layer above the plasma torches at or near the frustoconical portion 24 of the gasifier.

Biomass or other feed materials can then be added. For safety reasons, the preferred mode of operation is to limit the water content of the biomass to less than 5% until a suitable biomass bed is formed. The height of both the consumable catalyst bed and the operating biomass bed depends upon the size of the gasifier, the physico-chemical properties of the feed material, operating set points, and the desired processing rate. However, as noted, the preferred embodiment maintains the consumable catalyst bed above the level of the plasma torch inlets.

Steady-State Operation

When both the biomass bed and the catalyst bed reach the desired height, the system is deemed ready for steady operation. At this time, the operator can begin loading the mixed waste feed from the plant into the feeding system, which is set at a pre-determined throughput rate. The independent variables are also set at levels based on the composition of the biomass feed as pre-determined. The independent variables in the operation of the SPGV gasifier are typically:

A. Plasma Torch Power

B. Gas Flow Rate

C. Gas Flow Distribution

D. Bed Height of the Biomass and Catalyst

E. Feed Rate of the Biomass

F. Feed Rate of the Catalyst

During the steady state, the operator typically monitors the dependent parameters of the system, which include:

A. Exit Top Gas Temperature (measured at exit gas outlet)

B. Exit Top Gas Composition and Flow Rate (measured by gas sampling and flow meter at outlet described above)

C. Slag Melt Temperature and Flow Rate

D. Slag Leachability

E. Slag Viscosity

During operation and based on the above described principles, the operator may adjust the independent variables based upon fluctuations of the dependent variables. This process can be completely automated with pre-set adjustments based on inputs and outputs of the control monitors of the gasifier programmed into the DCS system of the plasma gasifier and the whole plant. The pre-set levels are normally optimized during the plant commissioning period when the actual biomass feed is loaded into the systems and the resultant exit top gas and slag behavior are measured and recorded. The DCS will be set to operate under steady state to produce the specific exit gas conditions and slag conditions at specified biomass feed rates. Variations in feed biomass composition will result in variations of the monitored dependent parameters, and the DCS and/or operator will make the corresponding adjustments in the independent variables to maintain steady state. An Artificial Intelligence based algorithm will introduced into the DCS system in order to collect and utilizes the data and information collected during the operations of the gasification systems including upset conditions to adopt into the gasifier's standard operating conditions to optimize the plant continual performance and avoid future problems.

Cooling and Scrubbing of the Exit Top Gas from the Plasma Gasifier

As mentioned above, one objective for the operation of the SPEG system is to produce a syngas with specific conditions (i.e., composition, calorific heating value, volume and purity and pressure of the renewable hydrogen) suitable for feeding into a plurality of industrial applications, including but not limited to gas turbine for production of renewable electrical energy, Fischer-Tropsch synthesis for production of transportation liquid fuels, production of renewable synthetic methane, combined heat and power system for production of high quality heat for cement kiln, used as high purity hydrogen for fuel cell vehicles, blended as renewable green hydrogen to decarbonize the natural gas pipeline or natural gas power plants, use the renewable hydrogen as reducing agent for Direct Reduced Iron in Steel mills, and finally as large storage of renewable hydrogen for use as renewable energy storage to balance the grid both in short term or in long seasonal storage.

Because the syngas is generated by the gasification of organic biomass material through the process described herein, there will exist certain amounts of biomass impurities, particulates and/or acid gases which are not suitable to the normal and safe operation of these systems. Procedures to clean the exit gas are described in the above mentioned Solena patents.

Exemplary embodiments of the present disclosure include:

### Embodiment 1

A plasma enhanced gasification reactor integrated with a LCO oxygen absorber system to convert biogenic hydrocarbon waste material comprising: a uniquely designed geometric designed reactor having an plenum section and a lower double bed section, said lower double bed section comprising a first, wider portion connected by a frustoconical transition to a second, narrower portion, and being suitable to receive a proprietary biochar carbon catalyst bed, and said upper section having one or more gas exit ports; a plurality of inlets for said material from a plurality of directions located at the upper part of said lower double bed section for introducing said material into said upper portion of said lower double bed section; a gas inlet system disposed around said lower section to provide oxidizing gas generated by the integrated LCO oxygen absorber system into said lower section through one or more intake ports in said lower double bed section; and a plurality of plasma arc torches mounted in said lower section to heat said biochar carbon catalyst bed and said biogenic hydrocarbon waste material.

### Embodiment 2

A plasma enhanced gasification reactor according to Embodiment 1, further comprising: a material delivery system to provide said material to said reactor through said plurality of intake ports, said delivery system comprising: a receptacle to receive said material, a shredding and compacting unit disposed to accept said material from said receptacle and to shred and compact said material, and a transfer unit to deliver said shredded and compacted material to said reactor.

### Embodiment 3

An apparatus according to Embodiment 2 wherein further comprising a separate feeding system to feed the biochar carbon catalyst materials into the reactor which is separate from the biogenic hydrocarbon feedstocks feeding system.

### Embodiment 4

An apparatus according to Embodiment 3 wherein said organic material comprises the non-fossilized and biodegradable organic material originating from products, by-products and residues of plants, municipal solid waste, agriculture waste, forestry waste and their related industries, all comprising biogenic hydrocarbon, in order to be converted into renewable green hydrogen for use in multiple applications.

### Embodiment 5

An apparatus according to any one of Embodiments 3 or 4 wherein said biochar carbon catalyst bed is about 1 meter in height.

### Embodiment 6

An apparatus according to any one of Embodiments 2-5 further comprising a plurality of sensors disposed throughout said reactor to sense one or more of: a height of said biochar carbon catalyst bed, a height of a bed of said biogenic hydrocarbon material, a temperature of said reactor, a flow rate of gas in said reactor, and a temperature of a syngas exhausted from said reactor through said exhaust port.

### Embodiment 7

An apparatus according to any one of Embodiments 1-6 wherein said lower section has one or more tap holes at a bottom thereof.

### Embodiment 8

A method for the conversion of biogenic hydrocarbon material by the plasma enhanced gasification reactor integrated with a LCO oxygen absorber into renewable green hydrogen, and its multiple downstream applications, said method comprising: providing a biochar carbon catalyst bed in a lower section of a reactor; providing one or more successive quantities of biogenic hydrocarbon waste material from a plurality of directions into an upper part of a lower double bed section of a reactor, said upper plenum section having at least one gas exhaust port connected to a fan, said biogenic hydrocarbon waste material forming a bed atop said biochar carbon catalyst bed; heating said biochar carbon catalyst bed and said biomass material bed using a plurality of plasma arc torches mounted in said lower section; and introducing into said lower section a gaseous oxidant that is generated by the integrated LCO oxygen absorber system.

### Embodiment 9

The method according to Embodiment 8 wherein said catalyst bed comprises of a proprietary biochar carbon materials with unique properties and containing solid carbon contents and ash, and has density and porosity retrieved for the functional operation of the plasma enhanced gasification described in embodiment 1 to 8.

### Embodiment 10

The process according to any one of Embodiments 8 or 9, wherein said gaseous oxidant comprises oxygen-enriched air or oxygen or steam at generated at atmospheric pressure from an integrated LCO oxygen absorber system to the plasma enhanced gasification reactor.

### Embodiment 11

The process according to Embodiment 10, wherein said oxygen-enriched air comprises at least about 80% to 95% (v/v) of oxygen as generated by the integrated LCO Oxygen absorber system.

### Embodiment 12

The process according to any one of Embodiments 8-14, wherein the temperature in the biochar carbon catalyst bed in the lower section is greater 3000.degree. C.

The term “comprising” (and its grammatical variations) as used herein is used in the inclusive sense of “having” or “including” and not in the exclusive sense of “consisting only of” The terms “a” and “the” as used herein are understood to encompass the plural as well as the singular. The term “atmospheric pressure” as used herein refers to atmospheric pressure (about 101325 Pa) and pressure below atmospheric pressure, wherein slightly below is typically up to about 500 Pa below atmospheric pressure and more typically about 200 Pa to about 500 Pa below atmospheric pressure.

The invention will be further described with reference to the following examples; however, it is to be understood that the invention is not limited to such examples. Rather, in view of the present disclosure that describes the current best mode for practicing the invention, many modifications and variations would present themselves to those of skill in the art without departing from the scope and spirit of this invention. All changes, modifications, and variations coming within the meaning and range of equivalency of the claims are to be considered within their scope.

### EXAMPLES

### Example 1

Use of Renewable Hydrogen to Decarbonize the Iron and Steel Industry

Iron ore is purified in traditional blast furnaces by being heated along with coke, a refined form of coal. Coke releases carbon monoxide that absorbs oxygen from the iron ore, creating pig iron and carbon dioxide. In an effort to introduce efficiencies and to comply with environmental regulations, steelmakers around the world are investigating the use of renewable hydrogen as a bonding agent in the iron and steel industry. Hydrogen produced by renewable power may be used to fire furnaces. Increasing the use of recycled steel is seen as critical to reducing emissions as it's far less energy-intensive.

Global demand for steel is expected to rise by 50% between 2019 and 2050 as cities grow. The International Energy Agency (IEA) says the carbon intensity of steel—the energy needed to produce a given amount—needs to fall 1.9% each year through 2030; however, between 2010 and 2016 the average decrease was 1.4%. The use of renewable energy, in particular renewable hydrogen is regarded as an important solution in reaching the goals set by the IEA.

Hydrogen is clearly advantageous when it is available as a by-product of the chemical industry or when a specific industry needs an uninterruptable power supply (as provided by a fuel cell), along with heat. As hydrogen can be combusted in hydrogen burners or be used in fuel cells, it offers a zero-emission alternative for heating. In addition, it is known that high-grade heat above 400° C. is harder to decarbonize, however, hydrogen burners can complement electric heating to generate high-grade heat. Furthermore, another advantage of the claimed technology is that hydrogen-based chemistry can serve as a carbon sink and complement or decarbonize parts of the petrochemical value chain.

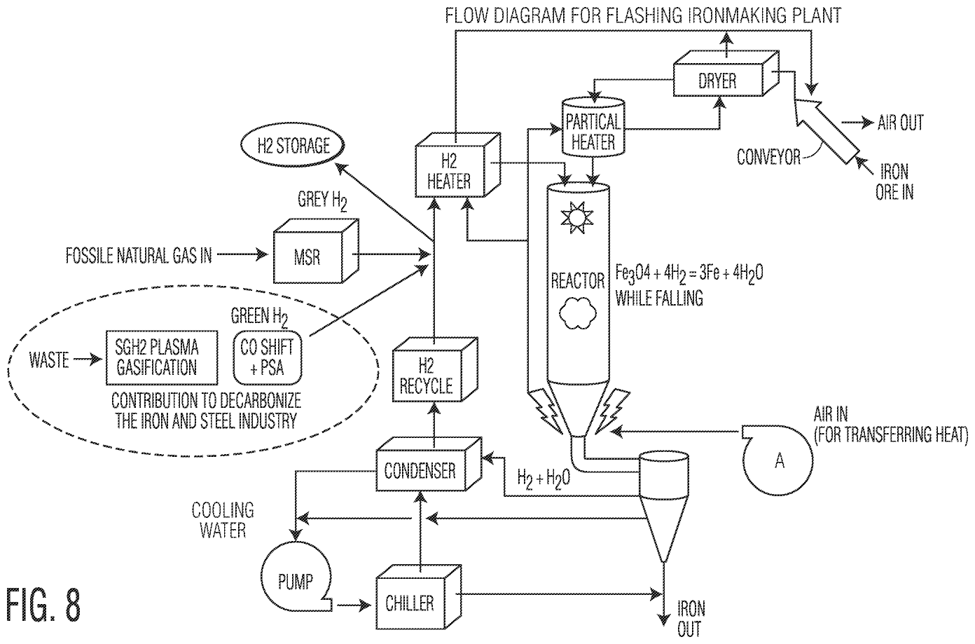

FIG. 8 provides a flow diagram demonstrating a representative approach for utilizing renewable hydrogen to introduce efficiencies and decarbonize the iron and steel industry.

### Example 2

Use of Renewable Hydrogen to Decarbonize Municipal Bus and Commercial Truck Sectors

Fuel cell electric vehicles (FCEVs) have an important role to play in decarbonizing transport. Today oil dominates the fuel mix that meets the world's transport needs. Gasoline and diesel account for 96% of total fuel consumption and 21% of global carbon emissions. Fully decarbonizing transport requires deployment of zero-emission vehicles like hydrogen-powered FCEVs and battery electric vehicles (BEVs), or hybrid combinations thereof. FCEVs offer several significant benefits. They can drive long distances without needing to refuel (already more than 500 km), a feature highly valued by consumers. They refuel quickly (3 to 10 minutes), similar to current gasoline/diesel cars, which adds to consumer convenience. Thanks to a much higher energy density of the hydrogen storage system (compared to batteries), the sensitivity of the FCEV powertrain cost and weight to the amount of energy stored (kWh) is low. This increases its attractiveness and likelihood of adoption of vehicles that require significant energy storage (e.g., heavy load capacity and/or long range/heavy use). FCEV infrastructure can build on existing gasoline distribution and retail infrastructure, creating cost advantages and preserving local jobs and capital assets. As cities and municipalities consider transitioning bus fleets away from diesel and toward electric powered vehicles, bus range and recharging/refueling times are critical considerations. At their best, battery buses have less range and lower hill-climbing performance than fuel cell electric buses.

Hydrogen is considered a preferred fuel source for at least the following reasons:

Hydrogen stores twice the energy of a standard bus battery at a fraction of the weight.

As a means of storing and transporting low-carbon fuel, hydrogen is an effective alternative to the electric grid.

When produced from renewable energy, hydrogen is a true zero-emission fuel that also enables grid-balancing and large-scale, long-term energy storage.

Fuel cell electric buses provide operator with zero emission transit without compromise:

Up to 300 miles range before refueling

Consistent power delivery during duty cycle

Depot gas refueling (like CNG) eliminates the need for a roadside charging infrastructure

Refueling is fast: less than 10 minutes of refueling delivers 18 hours of continuous service.

Compact central fueling infrastructure at depot

Operation and refueling is 1-to-1 comparable to diesel and CNG buses

The fuel cell electric bus is a 100% electric bus with a hybrid battery-fuel cell power train.

The fuel cell system acts as an onboard battery charger, using hydrogen as a high-density energy source.

The renewable hydrogen production methodology described herein may be used to produce hydrogen, compress it and transport it to hydrogen fueling stations. In an embodiment, further efficiencies may be realized by locating hydrogen production facilities in close proximity to sources of feedstock (disposal sites, landfills, agriculture waste compounds and the like). In an embodiment, hydrogen production and distribution may be designed in a coordinated way that can support clusters of transit depot fueling sites such that hydrogen is produced at strategically located production facilities that are close to transit agencies. The hydrogen is then transported relatively short distances in high pressure trailers to multiple fueling locations, and full trailers are simply swapped with empty trailers. At the production site, multiple trailers can be filled simultaneously, and likewise at the fueling sites multiple trailers can be positioned in trailer bays to provide flexibility in the logistics.

The use of renewable hydrogen is also considered to be a high-performance option for commercial trucking. As freight transportation is expected to increase 40% by 2050, the move toward cleaner trucking is being accelerated by government regulations and consumer pressure, with some manufacturers making significant investments. For heavy transport applications, there is growing consensus that the most suitable powertrain is hydrogen fuel cell electric. Fuel cells deliver the range, payload capacity, refuel time and all-weather performance that commercial trucking needs.

### Example 3

Use of Renewable Hydrogen to Decarbonize Cement Industry

Cement is a man-made powder that, when mixed with water and aggregates, produces concrete. The cement-making process can be summarized in 3 basic steps (1) raw material preparation, (2) clinker production in a kiln at a temperature of 1,450 degrees Celsius, and (3) the grinding of clinker with other minerals to produce cement.

The nature of hydrogen and natural gas combustion is quite similar. Methane (CH4, natural gas) is the closest carbonaceous fuel to hydrogen as it has fewer bonds compared to the other fossil fuels. The main differences are the radiation properties of a hydrogen flame and the flame size, which is smaller in hydrogen combustion.

Nevertheless, the burning process and the heat formation are still different when the hydrogen is combusted. Technically, due to its highly flammable characteristics, safety precautions must be taken to avoid dangers that may arise from hydrogen usage. Dilution with other gases may be a solution.

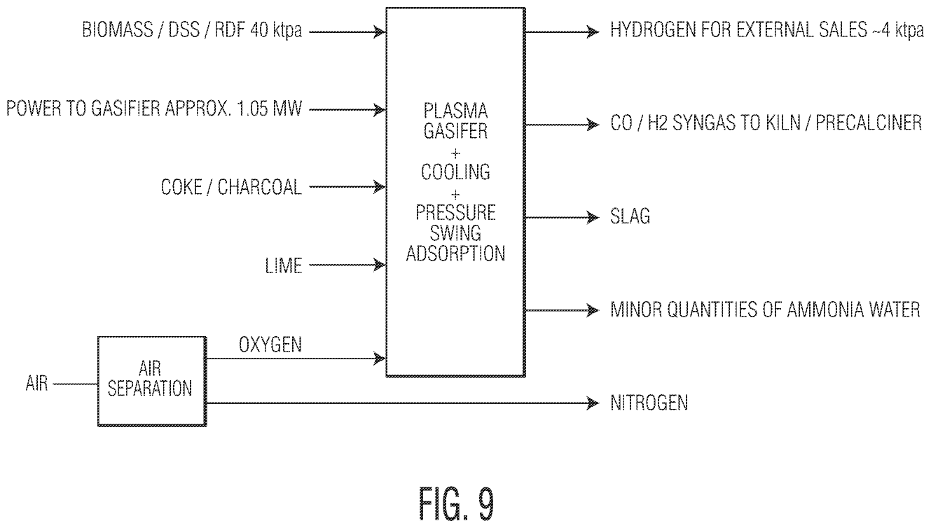

The main components of the syngas produced from the plasma gasifier are carbon monoxide and hydrogen. Although it is theoretically feasible to combust the syngas in a kiln/precalciner, the high market value of hydrogen makes it far more attractive to separate and sell the hydrogen. This leaves a syngas mainly comprising carbon monoxide, some carbon dioxide and lesser quantities of hydrogen for firing in the kiln/precalciner. The recommended configuration of the inventive plasma-gasification process for cement is shown FIG. 9.

The main synergies are: most cement plants have the supply and logistics for suitable alternative fuels in place and advantage can gained from the tipping fees which are available; (2) the carbon monoxide/hydrogen syngas produced can be fired in kiln/precalciner replacing fossil fuels and the reduction of CO2 emissions from the biomass element claimed by the cement plant; (3) it is possible that this syngas may be valuable for de NOx in the precalciner; (4) the waste slag produced may be used as a raw material or in cement; (5) sufficient power supply is already available for the plasma torches; (6) the availability of skilled labor for operations and maintenance; (7) space availability is usually good at a cement plant; (8) location at a brownfield industrial development may ease the permitting process; (9) the availability of small quantities of ammonia water could be used for de NOx; and (10) the cement plant may have suitable supplies of coke/charcoal and lime for the gasifier process.

### Example 4

Use of Renewable Hydrogen to Decarbonize Natural Gas Systems

An additional application of the novel hydrogen production methodology as described herein is for the decarbonization of natural gas systems. In an embodiment, hydrogen (H2) from renewable sources is injected into a natural gas network. This approach would allow the very large transport and storage capacities of the existing infrastructure, particularly underground storage facilities and high-pressure pipelines, to be used to decarbonize the Natural Gas System. Various studies have shown that most parts of the natural gas system can cope well with hydrogen addition of up to 10%, with no adverse effects.

All publications, patents and patent applications cited in this specification are herein incorporated by reference, and for any and all purpose, as if each individual publication, patent or patent application were specifically and individually indicated to be incorporated by reference. In the case of inconsistencies, the present disclosure will prevail.

The foregoing description of the disclosure illustrates and describes the present disclosure. Additionally, the disclosure shows and describes only the preferred embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The embodiments described hereinabove are further intended to explain best modes known of practicing it and to enable others skilled in the art to utilize the disclosure in such, or other, embodiments and with the various modifications required by the particular applications or uses. Accordingly, the description is not intended to limit it to the form disclosed herein. Also, it is intended that the appended claims be construed to include alternative embodiments. Each of the claims defines a separate invention, which for infringement purposes is recognized as including equivalents to the various elements or limitations specified in the claims.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

1. An apparatus for one stage plasma-enhanced gasification of biogenic hydrocarbon waste material comprising:
(a) a geometrically designed shaped reactor having an upper plenum section and a lower double bed section, said lower double bed section comprising a first, wider portion connected by a frustoconical transition to a second, narrower portion, and being suitable to receive a proprietary biochar carbon catalyst bed;
(b) said upper plenum section having at least one gas exit port;
(c) a plurality of inlets for said biogenic hydrocarbon waste material from a plurality of directions located at the upper part of said lower double bed section for introducing said material into said upper portion of said lower double bed section;
(d) a gas inlet system disposed around said lower section to provide oxidizing gas agent generated by an oxygen absorber system into said lower double bed section through one or more intake ports in said lower section;
(e) a plurality of inlets or tuyeres where plasma arc torches are mounted in said lower section to enhance the heat of oxidation generated from the biochar carbon catalyst bed and said biogenic hydrocarbon waste material to create an operating temperature of 3000 to 5000 degrees Celsius;
wherein the integrated oxygen absorber system provides oxidizing agents in the form of atmospheric pressured oxygen enriched air, oxygen or steam to generate an autothermal exothermic oxidation of the biogenic hydrocarbon waste materials.

2. An apparatus according to claim 1, further comprising: a material delivery system to provide said material to said reactor through said plurality of intake ports, said delivery system comprising: a receptacle to receive said material, a shredding and compacting unit disposed to accept said material from said receptacle and to shred and compact said material, and a transfer unit to deliver said shredded and compacted material to said reactor.

3. An apparatus according to claim 2 wherein said material comprises biomass material and biogenic hydrocarbon waste materials.

4. An apparatus according to claim 3 wherein said biomass and biogenic hydrocarbon waste material comprises the non-fossilized and biodegradable organic material originating from products, by-products and residues of plants, municipal solid waste, agriculture waste, and forestry waste.

5. An apparatus according to claim 1, wherein said biochar catalyst bed is about 0.5-10 meters, 1-5 meters or 1 meter in height.

6. An apparatus according to claim 2, further comprising a plurality of sensors disposed throughout said reactor to sense one or more of: a height of said biochar catalyst bed, a height of a bed of said material, a temperature of said reactor, a flow rate of gas in said reactor, and a temperature of a gas exhausted from said reactor through said exhaust port.

7. An apparatus according to claim 1, wherein said lower section has one or more tap holes at a bottom thereof in order to tap the molten lava created by the inert materials inside the feedstocks mixed with flux materials containing silica and calcium oxide.

8. A method for the conversion of organic material by one stage atmospheric plasma enhanced gasification, said method comprising the use of the apparatus of claim 1 and:
providing a catalyst bed primarily composed of a biochar material comprising dense solid carbon and ash in a lower section of a reactor;
providing one or more successive quantities of said biogenic hydrocarbon waste material from a plurality of directions into an upper part of a lower double bed section of a reactor, said upper plenum section having at least one gas exit port connected to an induction fan, said material forming a bed atop said biochar carbon catalyst bed;
providing enhanced heating of said biochar carbon catalyst bed and said biogenic hydrocarbon waste material bed using a plurality of plasma arc torches mounted in said lower double bed section;
and introducing into said lower double bed section a gaseous oxidant generated from the integrated oxygen absorber system at atmospheric pressure.

9. The method according to claim 8 wherein said catalyst bed comprises biochar carbon materials with unique density and porosity characteristics.

10. The process according to claim 8, wherein said gaseous oxidant generated by the oxygen absorber comprises oxygen-enriched air or oxygen or steam

11. The process according to claim 10, wherein said oxygen-enriched air comprises at least about 80% (v/v) of oxygen.

12. The process according to claim 10, wherein said oxygen-enriched air comprises at least about 95% (v/v) of oxygen.

13. The process according to claim 8, wherein the temperature in the biochar carbon catalyst bed in the lower section is greater 3000° C.
